(19) United States
(12) Patent Application Publication
(10) Pub. No.: US 2025/0278755 A1
(43) Pub. Date: Sep. 4, 2025

(54) SYSTEM AND METHOD FOR REAL-TIME DISTRIBUTION OF MEMBERSHIP INCENTIVES IN E-COMMERCE MARKETPLACES

(71) Applicant: Stephen EZELL, Williamsburg, MI (US)

(72) Inventor: Stephen EZELL, Williamsburg, MI (US)

(21) Appl. No.: 19/064,985

(22) Filed: Feb. 27, 2025

Related U.S. Application Data
(60) Provisional application No. 63/560,558, filed on Mar. 1, 2024.

(51) Int. Cl. G06Q 30/0207; G06Q 20/36; G06Q 30/0214

(52) U.S. Cl. CPC G06Q 30/0222; G06Q 20/3678; G06Q 30/0214

(57) ABSTRACT

A computer-implemented system providing participation incentives to buyers in an e-commerce marketplace is programmed or configured to: (i) allocate one or more virtual shares to each of one or more buyers/members in exchange for payment of a predetermined membership fee; (ii) provide a virtual wallet for each member, wherein the member can access their virtual wallet via a computing device; (iii) deduct in real-time from each sale made on the web-based marketplace a predetermined percentage of the monetary value of the sale, and transfer the deducted monetary value to a virtual exchange; and (iv) distribute to each member in real-time a pro-rata portion of the total monetary value of the virtual exchange at the time of distribution, wherein the pro rata portion distributed to each member is a function of the number of virtual shares held by that member and the total number of virtual shares in existence at the time of distribution. and wherein the pro rata portion of the total monetary value distributed to each member is allocated to that member's virtual wallet as one or more units of virtual currency. Each unit of the virtual currency has a predefined maximum monetary value and operates as at least one form of currency for purchasing the one or more products and/or services available via the web-based marketplace.

### CROSS-REFERENCE TO RELATED APPLICATIONS

The present invention is related to, and claims the benefit of priority from, U.S. Provisional Application Ser. No. 63/560,558, filed 1 Mar. 2024, the disclosure of which is incorporated herein by reference in its entirety.

### FIELD OF THE INVENTION

The present invention relates to e-commerce marketplaces and, more specifically, to a system and method for managing the real-time distribution of membership incentives in such marketplaces.

### BACKGROUND

E-commerce marketplaces where goods and/or services are sold are commonplace and used with increasing frequency. Typically, the provision of purchasing incentives to buyers in such e-commerce marketplaces take the form of incentives employed in “brick-and-mortar” retail environments. For instance, e-commerce sellers may offer discounted prices and/or the administrator of the e-commerce marketplace may offer discounted and/or free shipping of goods for a predetermined period of time in exchange for buyers paying a subscription or membership fee. Upon expiration of the predetermined period of time, each buyer must pay the fee again or lose the shipping incentive.

To date, however, Applicant is unaware of any e-commerce marketplace providing as an incentive a portion of the total monetary value of transactions occurring in the marketplace.

### SUMMARY OF THE DISCLOSURE

Disclosed herein is a computer-implemented system, and related method, for providing participation incentives to buyers in an e-commerce marketplace of the type where one or more sellers offer one or more products and/or services to one or more buyers who are members of the web-based marketplace. The computer-implemented system comprises at least one processor programmed or configured to: (i) allocate one or more virtual shares to each of the one or more members in exchange for payment of a predetermined membership fee to become members of the web-based marketplace; (ii) provide a virtual wallet for each member, and wherein the member can access their virtual wallet via a computing device; (iii) deduct in real-time from each sale made on the web-based marketplace a predetermined percentage of the monetary value of said sale, and transfer the deducted monetary value to a virtual exchange; and (iv) distribute to each member in real-time a pro-rata portion of the total monetary value of the virtual exchange at the time of distribution, wherein the pro rata portion distributed to each member is a function of the number of virtual shares held by that member and the total number of virtual shares in existence at the time of distribution, and wherein the pro rata portion of the total monetary value distributed to each member is allocated to that member's virtual wallet as one or more units of virtual currency. Each unit of the virtual currency has a predefined maximum monetary value and operates as at least one form of currency for purchasing the one or more products and/or services available via the web-based marketplace.

Per one feature, the at least one processor is programmed or configured to allocate to each of the one or more buyers one or more of units of the virtual currency in exchange for payment of the pre-determined. The one or more units of the virtual currency are allocated to that member-buyer's virtual wallet.

According to another feature, the at least one processor is programmed or configured to transfer one or more units of the virtual currency from a seller of goods and/or services on the e-commerce marketplace to a member upon the sale of the seller's goods and/or services to the member. The one or more units of the virtual currency are transferred to that member's virtual wallet in real-time upon consummation of the sale.

Per a sill further feature, the at least one processor is programmed or configured to deduct a predetermined percentage of the predetermined membership fee paid by each member for the one or more virtual shares and transfer that predetermined percentage to the virtual exchange. The predetermined percentage is deducted and transferred to the virtual exchange in real-time when the predetermined membership fee is paid.

According to a still further features, the at least one processor is programmed or configured to allocate one or more additional virtual shares to a member of the web-based marketplace in exchange for that member's payment of a predetermined fee.

Per another feature, the at least one processor is programmed or configured to store all allocated virtual shares in the virtual exchange.

According to yet another feature, the at least one processor is programmed or configured to allocate one or more additional virtual shares and a predetermined number of units of the virtual currency to a member of the web-based marketplace in exchange for that member's payment of a predetermined fee per virtual share, wherein said units of the virtual currency are stored in that member's virtual wallet.

According to still another feature, the at least one processor is programmed or configured to allocate a predetermined number of virtual shares and/or units of the virtual currency to a member upon the instance of that member's referral of a new member to the e-commerce marketplace, and wherein further said units of the virtual currency are stored in that member's virtual wallet.

Per another feature, the at least one processor is programmed or configured to provide for each member a member portal providing a graphical interface depicting the number and value of the units of the virtual currency in that member's virtual wallet.

### BRIEF DESCRIPTION OF THE DRAWINGS

The present invention will be appreciated from the following description and accompanying drawings, of which:

FIG. 1 diagrammatically depicts the virtual marketplace environment according to the present invention.

FIG. 2 diagrammatically depicts one arrangement for effecting the present invention.

FIG. 3 diagrammatically depicts functionalities of the computer-implemented system for providing participation incentives to buyers in an e-commerce marketplace, according to one embodiment.

FIG. 4 graphically depicts the marketplace M environment and the allocation A to the virtual exchange X of a predetermined percentage of the monetary value of a sale between a buyer B and seller S, as well as the distribution D to each member buyer's B virtual wallet in real-time of a pro-rata portion of the total monetary value of the virtual exchange at the time of distribution.

FIG. 5 graphically depicts a member portal P providing a graphical interface depicting the number and value of the units of the virtual currency in that member's virtual wallet.

FIG. 6 diagrammatically depicts functionalities of the computer-implemented system for providing participation incentives to buyers in an e-commerce marketplace, according to a further embodiment.

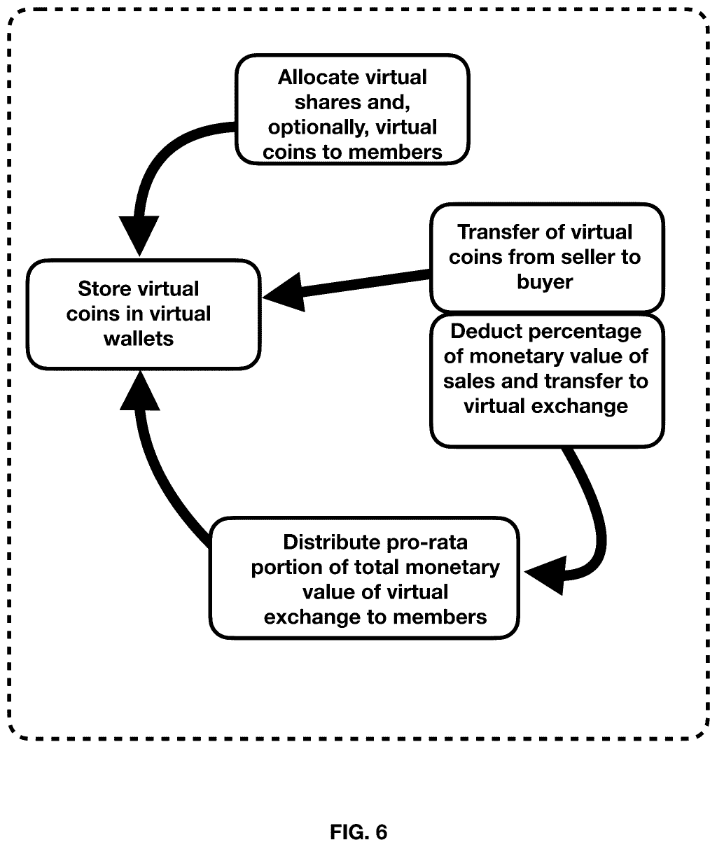

FIG. 7 diagrammatically depicts functionalities of the computer-implemented system for providing participation incentives to buyers in an e-commerce marketplace, according to a further embodiment.

### WRITTEN DESCRIPTION

As required, detailed embodiments of the present invention are disclosed herein. However, it is to be understood that the disclosed embodiments are merely exemplary of the invention that may be embodied in various and alternative forms. The accompanying drawings are not necessarily to scale, and some features may be exaggerated or minimized to show details of particular components. Therefore, specific details disclosed herein are not to be interpreted as limiting, but merely as a representative basis for teaching one skilled in the art to variously employ the present invention.

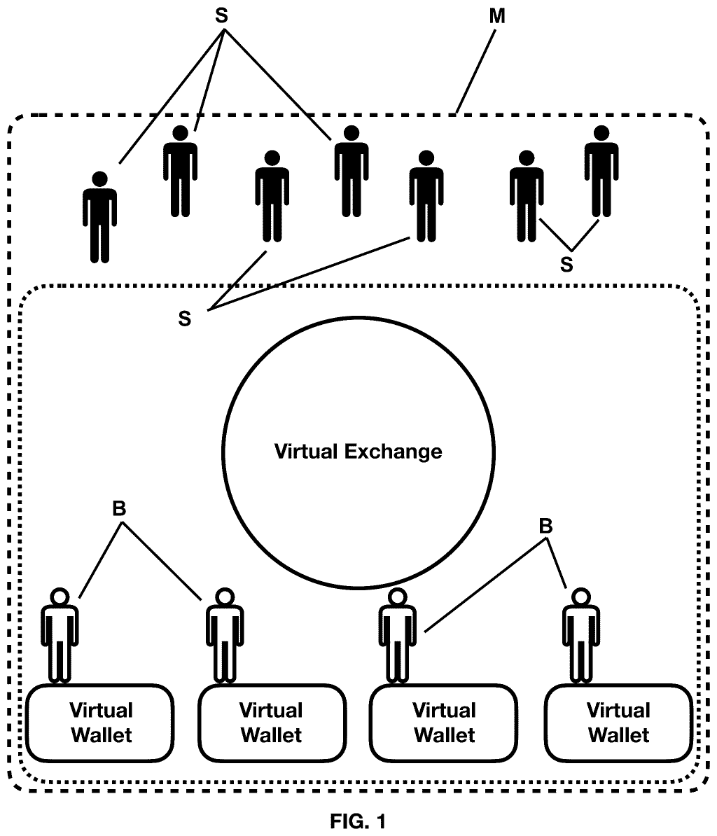

Referring now to the drawings, the present invention comprehends a system and method for managing the real-time distribution of membership incentives in an e-commerce marketplace of the type where one or more sellers offer one or more products and/or services to one or more buyers who are members of the marketplace. Such a marketplace environment M of buyers B and sellers S is represented in FIG. 1. Further depicted are components of the incentivizing system and methodology disclosed herein, including the virtual exchange X and buyer virtual wallets. These elements are depicted within the box contained within the marketplace M, representing the at least one processor for carrying out the present invention's functionalities.

As will be explained more fully herein, “members” refers to persons who have paid at least a predetermined fee in exchange for one or more benefits associated with the e-commerce marketplace. Such benefits include allocation of virtual shares per the invention of this disclosure, and may also optionally include one or more of special discounts, free shipping, reduced-price shipping, special offers, as well as any other types of benefits that are conventionally extended to members in e-commerce marketplaces.

It should be understood that the e-commerce marketplace contemplated in this disclosure need not be accessible only to “members.” It may also be accessible to non-members, though in such case members would have at least some benefits—such as mentioned above—not available to non-members. Where the e-commerce marketplace is accessible only to members, the terms “members” and “buyers” should be understood to be interchangeable. Where the e-commerce marketplace is accessible to members and non-members, on the other hand, the term “buyers” should be understood to refer to both member buyers and non-member buyers.

It should also be understood that the term of membership is not critical to the present invention. Rather, membership may be for any desired term, and may be subject to extension or cancellation by the member and/or the party providing the membership; e.g., the party hosting the e-commerce marketplace.

Per convention, “sellers” in the e-commerce marketplace will be persons (natural and/or juristic) who have contracted with the party hosting the e-commerce marketplace M to offer their goods and/or services to buyers.

Per the present invention, the e-commerce marketplace M may be a third party marketplace or, alternatively, may be hosted by the same party offering the incentivizing system and methodology disclosed herein. The marketplace M is virtual in nature and may be accessible to buyers and sellers alike via any computing device, such as any of a laptop computer, a desktop computer, a tablet computer, a handheld computer/cellphone, etc.

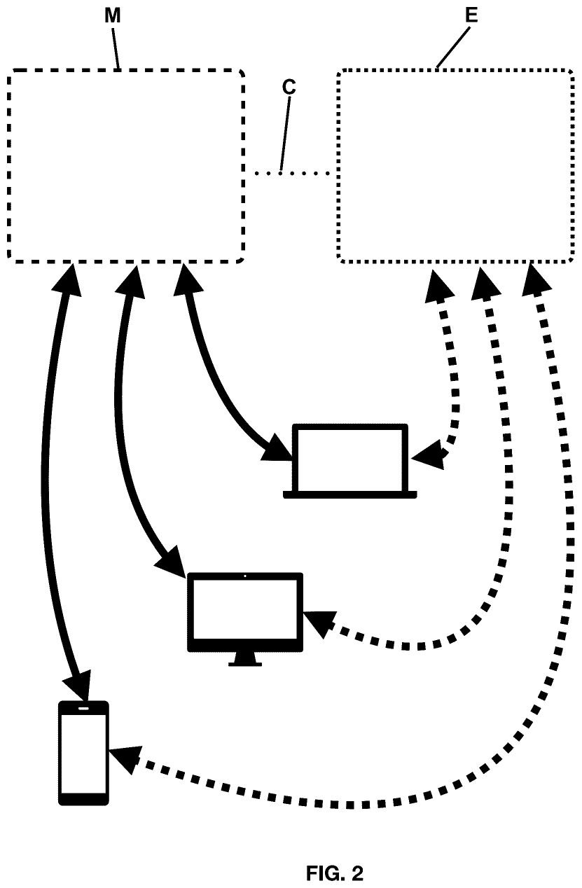

Referring to FIG. 2, there is depicted an embodiment wherein the marketplace M exists in a first virtual environment and the system for carrying out the present invention exists in a second environment E hosting one or more processors operative for carrying out the functionalities described herein. As depicted, the marketplace M and the environment E are in communication (represented by the line C) so that necessary data may be shared between them, such as information respecting sales in the marketplace for purposes of deducting a percentage of the monetary value of the sale for transfer to the virtual exchange in the environment E. While the solid arrows represent access to the marketplace M, the dashed arrows in FIG. 2 depict access between the second environment E and at least the computing devices of buyers so that they may have access to their virtual wallets.

Still referring to the drawings, the system of the present invention most generally comprises at least one processor programmed or configured to do the following:

First, to allocate one or more virtual shares to each of the one or more members in exchange for payment of a pre-determined membership fee to become members of the web-based marketplace. That is, a buyer paying a predetermined fee to become a member of the e-commerce marketplace is allocated one or more virtual shares as al least partial consideration for the membership fee. As described above, the member may optionally be accorded one or more additional benefits for membership. Each “virtual share” represents a fractional interest in an asset defined as a percentage of the proceeds from sales in the e-commerce marketplace. The fractional interest represented by each virtual share is a function of the number of virtual shares outstanding, such that each virtual share represents an equal interest in the asset.

Second, to provide a virtual wallet for each member. The member can access their virtual wallet via a computing device. The computing device may be any of a laptop computer, a desktop computer, a tablet computer, a handheld computer/cellphone, etc. It is contemplated that each member's virtual wallet exists, in whole or in part, on one or more servers that may be remotely accessed by the member.

Third, to deduct in real-time from each sale made on the e-commerce marketplace a predetermined percentage of the monetary value of the sale, and transfer the deducted monetary value to a virtual exchange. The “virtual exchange” X (shown in FIGS. 1, 4 and 5) is a virtual repository defined in one or more servers. That is, as each sale is consummated in the marketplace—i.e., in “real time”—a predetermined percentage of the monetary value of that sale is deducted and allocated to the exchange. The virtual exchange thus constitutes the repository for the asset in which the virtual shares represent the corresponding interest.

Fourth, to distribute to each member in real-time a pro-rata portion of the total monetary value of the virtual exchange at the time of distribution, wherein the pro rata portion distributed to each member is a function of the number of virtual shares held by that member at the time of distribution and the total number of virtual shares in existence at the time of distribution. That is, as the monetary value of sales is allocated to the virtual exchange it is distributed to members according to the total of the virtual shares outstanding at the time of distribution and the number, or percentage, of those outstanding virtual shares held by each member.

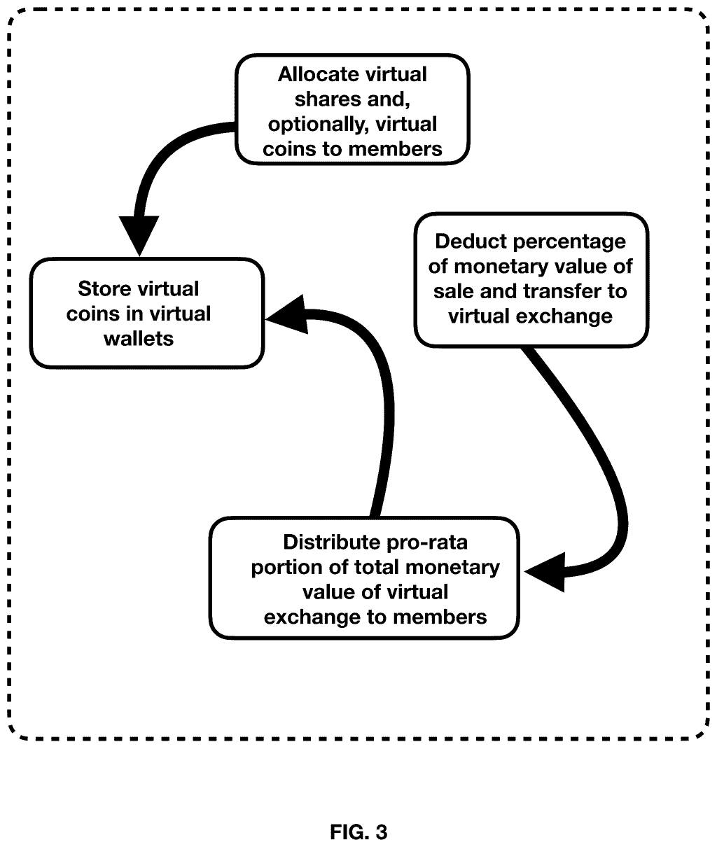

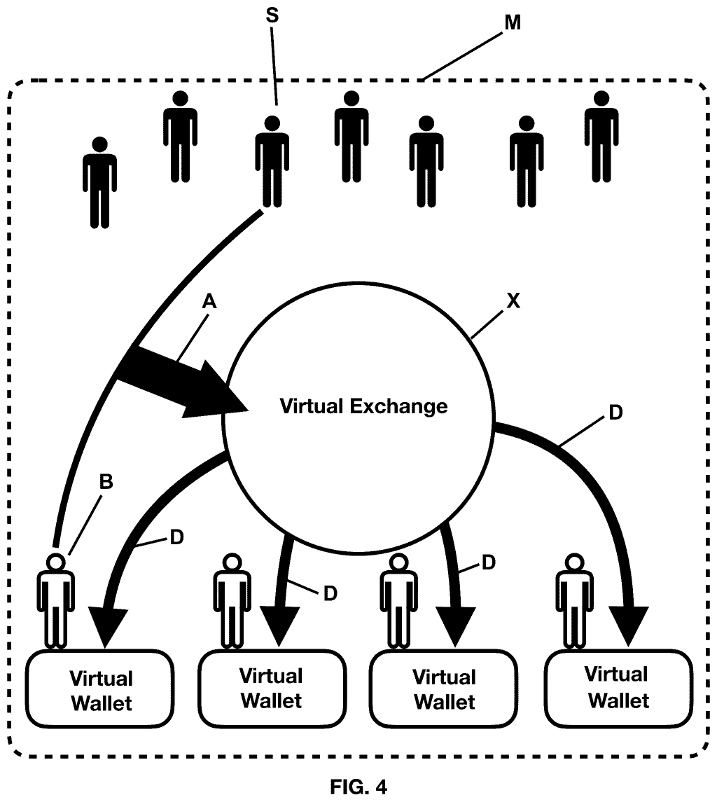

The foregoing functionalities are depicted in FIG. 3. FIG. 4 also graphically depicts the marketplace M environment and the allocation A to the virtual exchange X of a predetermined percentage of the monetary value of a sale between a buyer B and seller S, as well as the distribution D to each member buyer's B virtual wallet in real-time of a pro-rata portion of the total monetary value of the virtual exchange at the time of distribution.

In part, the member's virtual wallet may also reside on software, such as an “app.” on the member's computing device. In these regards, it is contemplated that the app may provide an interface with the data on the one or more servers corresponding to the member's wallet information.

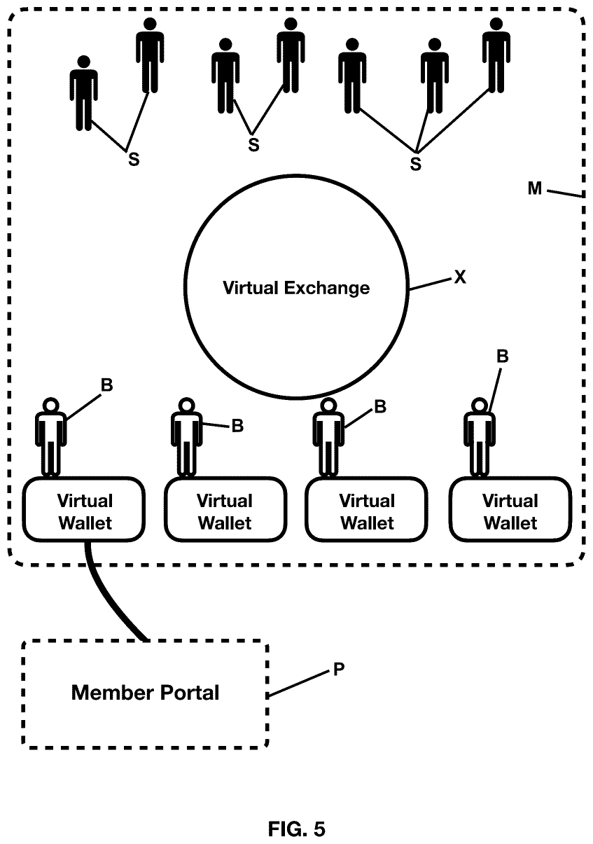

The at least one processor may be programmed or configured to provide for each member a member portal P providing a graphical interface depicting the number and value of the units of the virtual currency in that member's virtual wallet. This is shown in FIG. 5.

By way of example of the pro-rata distribution of the monetary value in the exchange, if there are at the time of distribution 10 outstanding virtual shares held by 10 members, and the monetary value of the exchange at the time of distribution is $100, then the value distributed to each member would be $10.

However, the present invention contemplates that the value distributed to the members is allocated as one or more units of virtual currency rather than as units of actual currency, where each such unit of the virtual currency has a predefined maximum monetary value and operates as at least one form of currency for purchasing products and/or services available via the e-commerce marketplace.

The units of virtual currency may have any desired denominational value on an individual basis, and that value may, as desired, correspond to real-world denominations. So, by way of non-limiting example, each unit of virtual currency may be $1, $5, etc. (USD). Particularly in view of the real-time distribution to members of pro rata shares of the monetary value of the virtual exchange, it will be appreciated that the amounts distributed to, and accumulated by, members may reflect amounts outside of a selected denomination for the virtual currency. For instance, a given distribution may result in a member's wallet holding an amount representing a fraction of Dollar. Where each unit of virtual currency is assigned a Dollar value, such as $1 (USD), it is contemplated that the member's wallet would hold the fractional amount in a unit of the virtual currency, but that that particular unit of virtual currency would have be unusable in the e-commerce exchange until, through future distributions from the virtual exchange, it reached the assigned value of unit. Again, by way of example, if a unit of virtual currency was set al $1 (USD) and the member's wallet had a monetary value of 50 cents, the user's wallet would reflect the existence of a partial unit of virtual currency. Alternatively, it is contemplated that such fractional units of the virtual currency could be used without restriction in the e-commerce marketplace. In another variation, the virtual currency could correspond to real world currency in all denominations.

Optionally, the at least one processor is programmed or configured to further allocate to each of the one or more members one or more units of the virtual currency (referred to as “virtual coins” in the drawings) in exchange for payment of the predetermined membership fee. These one or more units of the virtual currency are allocated to that member-buyer's virtual wallet. In other words, upon payment of the predetermined membership fee, the member is allocated one or more virtual shares and, moreover, one or more units of the virtual currency. This optional functionality is also shown in FIG. 3.

Optionally, the at least one processor may be programmed or configured to transfer one or more units of the virtual currency from a seller of goods and/or services on the e-commerce marketplace to a member upon the sale of the seller's goods and/or services to the member. This is depicted in FIG. 5. The one or more units of the virtual currency are transferred to that member-buyer's virtual wallet in real-time upon consummation of the sale. In other words, the system permits sellers to offer members one or more units of the virtual currency as an incentive to purchase the sellers' goods and/or services. To effect this, it is contemplated that sellers purchase each unit of virtual currency transferred, paying the value therefor to the operator of the e-commerce marketplace. This may be accomplished at the time of consummation of the sale or beforehand, the seller in the latter instance “holding” the virtual currency until the sale is consummated.

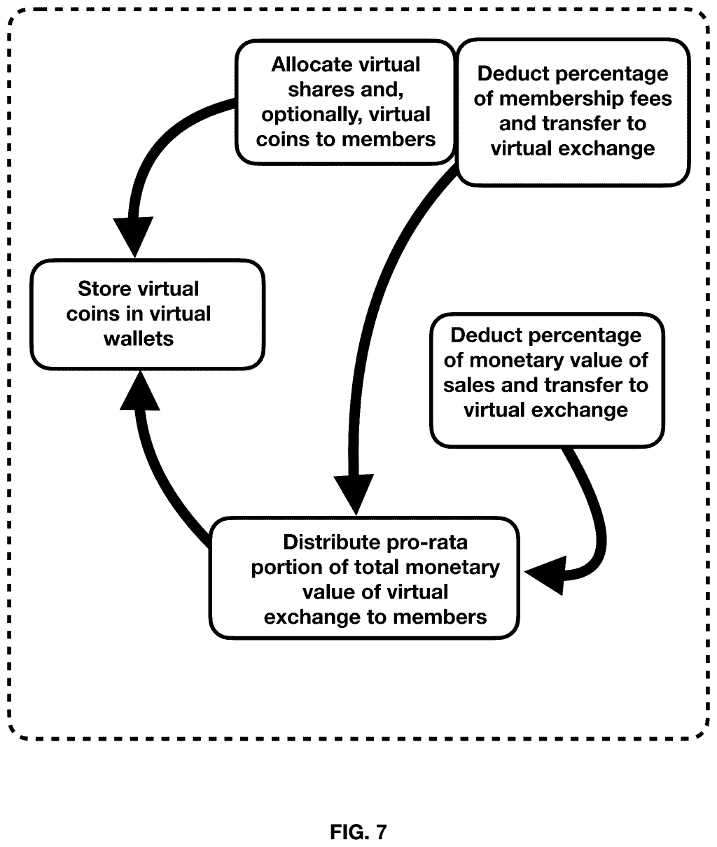

Optionally, the at least one processor is also programmed or configured to deduct a predetermined percentage of the membership fee paid by each member and transfer that predetermined percentage to the virtual exchange. This functionality is depicted in FIG. 7. This predetermined percentage is deducted and transferred to the virtual exchange in real-time when the membership fee is paid by each member. That value is then allocated, in real-time, to members (optionally, including the member(s) from whose membership fee the predetermined percentage was just deducted) in units of virtual currency and according to the total of the virtual shares outstanding at the time of distribution and the percentage of virtual shares held by each member.

Optionally, the system is operative to permit an administrator to allocate a number units of the virtual currency to a member as an incentive or gift, irrespective of any of the number of shares held by the member, the amount of any prior payments into the exchange, and/or the amount of prior purchases made on the e-commerce marketplace. Those further units of the virtual currency are stored in that member's virtual wallet.

Optionally, the system of the present invention is also operative to permit members to purchase virtual shares in addition to the one or more virtual shares allocated to each member upon payment of the predetermined membership fee. Each such additional virtual share purchased has a predetermined cost. By this feature, members are permitted to voluntarily increase the number of their virtual shares and, correspondingly, their interest in the value of the virtual exchange. All or a predetermined fraction of the monetary value of the predetermined cost paid for additional virtual shares may, optionally, also be allocated to the virtual exchange.

Alternatively, the system of the present invention may be operative to permit members to purchase a combination of virtual shares and virtual currency in addition to the one or more virtual shares (and, optionally, virtual currency) allocated to each member upon payment of the predetermined membership fee. Each such additional virtual share/virtual currency combination purchased has a predetermined cost. All or a predetermined fraction of the monetary value of the predetermined cost paid for additional virtual shares/virtual currency combination may, optionally, also be allocated to the virtual exchange. The units of the virtual currency are stored in that member's virtual wallet.

Optionally, the system is operative to allocate a predetermined number of virtual shares and/or units of the virtual currency to a member upon the instance of that member's referral of a new member to the e-commerce marketplace. Those further units of the virtual currency are stored in that member's virtual wallet. In other words, the system is operative to incentivize each member to get others to become members of the e-commerce marketplace.

According to any of the above-described features or variants of the invention, the virtual shares may be “stored” in the virtual exchange in the sense that the same database of information reflecting the monetary value of the virtual exchange may also contain information reflecting the number of outstanding shares and the identity of, or information sufficient to identify, the owner of those virtual shares.

It is to be understood that the predetermined amounts, whether fees or quantities, may be set according to the preference. the precise amounts being immaterial to the subject invention.

The foregoing description of the exemplary embodiments of the invention has been presented for purposes of illustration and description. It is not intended to be exhaustive or to limit the invention to the precise form disclosed, and modifications and variations are possible in light of the above teachings or may be acquired from practice of the innovation. The embodiments are shown and described in order to explain the principles of the innovation and its practical application to enable one skilled in the art to utilize the innovation in various embodiments and with various modifications as are suited to the particular use contemplated. Although only a few embodiments of the present innovations have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present innovations. Other substitutions, modifications, changes and omissions may be made in the design, operating conditions and arrangement of the exemplary embodiments without departing from the spirit of the present innovations.

The invention in which an exclusive property or privilege is claimed is defined as follows:

1. A computer-implemented method for providing participation incentives to buyers in an e-commerce marketplace, comprising the following steps:
providing a web-based marketplace wherein one or more sellers offer one or more products and/or services to one or more buyers who are members of the web-based marketplace, wherein each of the one or more members are allocated one or more virtual shares in exchange for payment of a pre-determined membership fee to become members of the web-based marketplace;
providing each member with a virtual wallet, accessible to that member via a computing device; and
deducting in real-time from each sale made on the web-based marketplace by each of the one or more sellers a predetermined percentage of the monetary value of said sale, and transferring the deducted monetary value to a virtual exchange;
distributing to each member in real-time a pro-rata portion of the total monetary value of the virtual exchange at the time of distribution, wherein the pro rata portion distributed to each member is a function of the number of virtual shares held by that member and the total number of virtual shares in existence at the time of distribution, and wherein the pro rata portion of the total monetary value distributed to each member is allocated to that member's virtual wallet as one or more units of virtual currency;
wherein each unit of the virtual currency has a predefined maximum monetary value and operates as at least one form of currency for purchasing the one or more products and/or services available via the web-based marketplace.

2. The computer-implemented method of claim 1, wherein further each of the one or more buyers are allocated one or more of units of the virtual currency in exchange for payment of the pre-determined membership fee, and wherein said one or more units of the virtual currency are allocated to that member-buyer's virtual wallet.

3. The computer-implemented method of claim 1, wherein further each of the one or more sellers is enabled to incentivize sales of their respective goods and/or services through the allocation of one or more units of virtual currency to a member upon the sale the seller's goods and/or services to the member, and wherein the one or more units of the virtual currency are allocated to that member's virtual wallet in real-time upon consummation of the sale.

4. The computer-implemented method of claim 1, wherein further a predetermined percentage of the predetermined membership fee paid by each member in exchange for the allocated one or more virtual shares is deducted in real-time and transferred to the virtual exchange.

5. The computer-implemented method of claim 1, wherein further each member can purchase one or more additional virtual shares at a predetermined fee.

6. The computer-implemented method of claim 5, wherein further the virtual exchange stores all allocated virtual shares.

7. The computer-implemented method of claim 5, wherein further the purchase of each additional virtual share is accompanied by the allocation to the purchasing member of a predetermined number of units of the virtual currency, and wherein further said units of virtual currency are stored in the purchasing member's virtual wallet.

8. The computer-implemented method of claim 1, wherein each member is incentivized to refer new members to the web-based marketplace by the allocation of a predetermined number of virtual shares and/or units of the virtual currency to the referring member, and wherein further said units of the virtual currency are stored in the purchasing member's virtual wallet.

9. The computer-implemented method of claim 8, wherein further the virtual exchange stores all allocated virtual shares.

10. The computer-implemented method of claim 1, wherein further there is provided a member portal where each member has access to a graphical interface depicting the units of the virtual currency in their virtual wallet.

11. A computer-implemented system for providing participation incentives to buyers in an e-commerce marketplace wherein one or more sellers offer one or more products and/or services to one or more buyers who are members of the web-based marketplace, the system comprising:
at least one processor programmed or configured to:
(i) allocate one or more virtual shares to each of the one or more members in exchange for payment of a pre-determined membership fee to become members of the web-based marketplace;
(ii) provide a virtual wallet for each member, and wherein the member can access their virtual wallet via a computing device;
(iii) deduct in real-time from each sale made on the web-based marketplace a predetermined percentage of the monetary value of said sale, and transfer the deducted monetary value to a virtual exchange; and
(iv) distribute to each member in real-time a pro-rata portion of the total monetary value of the virtual exchange at the time of distribution, wherein the pro rata portion distributed to each member is a function of the number of virtual shares held by that member and the total number of virtual shares in existence at the time of distribution, and wherein the pro rata portion of the total monetary value distributed to each member is allocated to that member's virtual wallet as one or more units of virtual currency;
wherein each unit of the virtual currency has a predefined maximum monetary value and operates as at least one form of currency for purchasing the one or more products and/or services available via the web-based marketplace.

12. The computer-implemented system of claim 11, wherein further the at least one processor is programmed or configured to allocate to each of the one or more buyers one or more of units of the virtual currency in exchange for payment of the pre-determined membership fee, and wherein said one or more units of the virtual currency are allocated to that member-buyer's virtual wallet.

13. The computer-implemented system of claim 11, wherein further the at least one processor is programmed or configured to transfer one or more units of the virtual currency from a seller of goods and/or services on the e-commerce marketplace to a member upon the sale of the seller's goods and/or services to the member, and wherein the one or more units of the virtual currency are transferred to that member's virtual wallet in real-time upon consummation of the sale.

14. The computer-implemented system of claim 11, wherein further the at least one processor is programmed or configured to deduct a predetermined percentage of the membership fee paid by each member and transfer that predetermined percentage to the virtual exchange, wherein the predetermined percentage is deducted and transferred to the virtual exchange in real-time when the membership fee is paid.

15. The computer-implemented system of claim 11, wherein further the at least one processor is programmed or configured to allocate one or more additional virtual shares to a member of the web-based marketplace in exchange for that member's payment of a predetermined fee.

16. The computer-implemented system of claim 15, wherein further the at least one processor is programmed or configured to store all allocated virtual shares in the virtual exchange.

17. The computer-implemented system of claim 11, wherein further the at least one processor is programmed or configured to allocate one or more additional virtual shares and a predetermined number of units of the virtual currency to a member of the web-based marketplace in exchange for that member's payment of a predetermined fee per virtual share, wherein said units of the virtual currency are stored in that member's virtual wallet.

18. The computer-implemented system of claim 17, wherein further the at least one processor is programmed or configured to store all allocated virtual shares in the virtual exchange.

19. The computer-implemented system of claim 11, wherein further the at least one processor is programmed or configured to allocate a predetermined number of virtual shares and/or units of the virtual currency to a member upon the instance of that member's referral of a new member to the e-commerce marketplace, and wherein further said units of the virtual currency are stored in that member's virtual wallet.

20. The computer-implemented system of claim 19, wherein further the at least one processor is programmed or configured to store all allocated virtual shares in the virtual exchange.

21. The computer-implemented system of claim 11, wherein further the at least one processor is programmed or configured to provide for each member a member portal providing a graphical interface depicting the number and value of the units of the virtual currency in that member's virtual wallet.

22. The computer-implemented system of claim 11, wherein further the at least one processor is programmed or configured to store all allocated virtual shares in the virtual exchange.
